(19) United States
(12) Patent Application Publication
(10) Pub. No.: US 2026/0173118 A1
(43) Pub. Date: Jun. 18, 2026

(54) SYSTEM AND METHOD FOR ADAPTIVE WIRELESS BROADCAST COMMUNICATION

(71) Applicant: SAMSUNG ELECTRONICS CO., LTD., Suwon-si (KR)

(72) Inventor: Anupam ROY, Noida Uttar Pradesh (IN)

(73) Assignee: SAMSUNG ELECTRONICS CO., LTD., Suwon-si (KR)

(21) Appl. No.: 19/533,733

(22) Filed: Feb. 9, 2026

Related U.S. Application Data
(63) Continuation of application No. PCT/IB2024/061649, filed on Nov. 21, 2024.

(30) Foreign Application Priority Data
Dec. 15, 2023 (IN) 202311085902

(51) Int. Cl. H04W 72/30; H04W 28/02; H04W 72/1263

(52) U.S. Cl. CPC H04W 72/30; H04W 28/0268; H04W 72/1263

(57) ABSTRACT

A method of adaptive wireless broadcast communication may include: receiving an input to enable an adaptive broadcast mode; determining an optimal Quality of Service (QoS) range and position information of a broadcast transmitter; generating a broadcast packet embedded with the optimal QoS range, the position information, a broadcast stream identifier, and time synchronization information; generating an assistive batch corresponding to a broadcast stream and including the broadcast packet; based on a total number of active broadcast streams, window length information, and/or channel map information, determining an unused broadcast channel, a beacon batch window, a per window beacon density, or a beacon batch chaining interval; scheduling the assistive batch to be transmitted based on the unused broadcast channel, the beacon batch window, the per window beacon density, or the beacon batch chaining time interval; and transmitting the assistive batch by interleaving the assistive batch with an adaptive broadcast stream.

### CROSS-REFERENCE TO RELATED APPLICATIONS

This application is a bypass continuation of International Application No. PCT/IB2024/061649, filed on Nov. 21, 2024, which is based on and claims priority to Indian Patent Application Ser. No. 202311085902, filed Dec. 15, 2023, in the Indian Intellectual Property Office, the disclosures of which are incorporated by reference herein in their entireties.

### BACKGROUND

### Field

The present disclosure generally relates to a method and a system for adaptive wireless broadcast communication. In particular, the present disclosure discloses an optimal range-assisted adaptive wireless broadcast communication.

### Description of Related Art

Audio broadcast systems are communication platforms that stream audio content to one or more users. These systems capture, encode, and transmit the audio content as a broadcast stream, which is then decoded and played through earbuds, speakers, headphones, radios, televisions, or digital devices. They are commonly used for broadcasting live events, music, news, educational content, and other forms of audio entertainment or information to a broad and diverse audience.

Recently, low-energy (LE) audio broadcast systems that utilize Bluetooth technology have changed the audio experiences of the user and the way the user engages with another user. Such broadcast systems enable the streaming of the broadcast stream wirelessly with improved sound quality while consuming low power. The LE audio broadcast system provides features such as multi-stream audio, hearing aid support, etc. The aforementioned features make it suitable for a wide range of devices such as wireless headphones, wireless earbuds, hearing aids, smart home devices, and the like.

In a multi-stream audio scenario, the LE audio broadcast system typically allows a single transmitting device, such as a smartphone or tablet, to simultaneously stream audio content to multiple receiving devices, such as individual wireless earbuds or headphones.

For example, consider a person using a smartphone to stream music. With the LE audio broadcast system with multi-stream support, the smartphone can simultaneously transmit the audio content to multiple pairs of wireless earbuds or headphones worn by different individuals. This means that several users can listen to the same audio content from a single transmitting device without the need for additional accessories or hardware.

However, the existing audio broadcast systems or the LE audio broadcast system do not consider the quality of reception based on an optimum ranging threshold. Wireless transmission signal has a threshold distance to deliver the best data. When transmissions exceed the threshold distance, the quality is compromised, and users lack control over the quality of reception.

In order to overcome the above problem, the conventional solutions perform hiding certain broadcast contents. However, in such cases the user will potentially never come to know about the nearby wireless broadcasts. While some systems attempt to address this issue by implementing quality feedback reception from a broadcast receiver system, however, it is impossible to receive feedback from an unlimited number of receivers, due to the limitation of the number of dedicated connections supported by any wireless radio system.

Thus, there is a need to provide a methodology to overcome the above-mentioned issues in the conventional techniques.

### SUMMARY

This summary is provided to introduce a selection of concepts in a simplified format that are further described in the detailed description of the invention. This summary is not intended to identify key or essential inventive concepts of the invention, nor is it intended for determining the scope of the invention.

In accordance with the present disclosure, a method for adaptive wireless broadcast communication may include: receiving an input configured to enable an adaptive broadcast mode of a broadcast transmitter; based on the received input, determining an optimal Quality of Service (QoS) range in which the broadcast transmitter is able to transmit data to a receiver without data loss and position information of the broadcast transmitter; generating a broadcast beacon packet correlated to a main broadcast packet and embedded with the determined optimal QoS range, the determined position information, a broadcast stream identifier, and time synchronization information; generating an assistive beacon batch corresponding to a broadcast stream, the assistive beacon batch including the generated broadcast beacon packet; based on at least one of a total number of active broadcast streams, window length information, and channel map information, determining an unused broadcast channel from among a plurality of broadcast channels of the broadcast transmitter, a beacon batch window, a per window beacon density, or a beacon batch chaining interval; scheduling the assistive beacon batch to be transmitted based on the determined unused broadcast channel, the determined beacon batch window, the determined per window beacon density, or the determined beacon batch chaining time interval; and transmitting the scheduled assistive beacon batch in accordance with the scheduling by interleaving the scheduled assistive beacon batch with an adaptive broadcast stream.

The method may further include: monitoring periodically a position of the broadcast transmitter, determining, within a time interval, updated position information corresponding to a change in the position of the broadcast transmitter based on the monitoring, and updating, based on determination of the change in the position of the broadcast transmitter, the assistive beacon batch by embedding the determined updated position information into the assistive beacon batch, wherein the determined position information embedded in the broadcast beacon packet is updated to include the determined updated position information.

The determining the position information of the broadcast transmitter may include: receiving acceleration data and/or global positioning service (GPS) data from a sensor of the broadcast transmitter, and determining the position information based on the received acceleration data and/or the received GPS data.

The determining the updated position information corresponding to the change in the position of the broadcast transmitter may include: receiving acceleration data and/or global positioning service (GPS) data from a sensor of the broadcast transmitter, and determining, within the time interval, the updated position information based on the received acceleration data and/or the received GPS data, wherein the updated position information is position information of the broadcast transmitter with respect to an immediate previous position of the broadcast transmitter.

The determining the optimal QoS range may include accounting for the change in the position of the broadcast transmitter which may include: monitoring a parameter of a sensor of the broadcast transmitter, determining a path loss based on the monitored parameter, and determining the optimal QoS range with respect to the change in the position of the broadcast transmitter based on the determined path loss.

The monitored parameter may include at least one of an output power of the broadcast transmitter, a sensitivity of a receiver configured to receive a broadcast of the broadcast transmitter, a physical obstacle in a transmission path between the broadcast transmitter and the receiver, and an antenna gain obtained from the sensor.

The method may further include: generating the adaptive broadcast stream including adaptive broadcast support information and the broadcast stream identifier embedded in a header of the adaptive broadcast stream, wherein the adaptive broadcast support information indicates whether the adaptive broadcast mode is enabled or disabled, and the broadcast stream identifier identifies the broadcast stream that is broadcasted via the adaptive broadcast stream.

The assistive beacon batch may be scheduled to be transmitted before an onset of transmission of the adaptive broadcast stream, and transmission of the generated broadcast beacon packet included in the scheduled assistive beacon batch starts at an immediate time slot after the adaptive broadcast mode is enabled.

Transmitting the scheduled assistive beacon batch may include: interleaving, in the determined beacon batch window, the assistive beacon batch including the generated broadcast beacon packet at the determined beacon batch chaining time interval, each generated broadcast beacon packet including a time stamp of a next periodic position update value, and a receiver performs a decoding operation on the generated broadcast beacon packet at the time stamp of the next periodic position update value in case the receiver misses to perform the decoding operation in accordance with the time synchronization information.

The method may further include: receiving an input configured to disable the adaptive broadcast mode; triggering a tear-down request to cease streaming of a current set of assistive beacon batches among a plurality of scheduled assistive beacon batches; and terminating transmission of a next set of assistive beacon batches among the plurality of scheduled assistive beacon batches that are scheduled to be transmitted in the determined beacon batch window at a next time instance with respect to a current time instance, wherein the current set of assistive beacon batches are allowed to be transmitted in the determined beacon batch window at the current time instance.

The method may further include: until an input to re-enable the adaptive broadcast mode is received, transmitting a default broadcast stream based on the termination of the next set of assistive beacon batches.

The beacon batch window may represent a time period of transmitting the assistive beacon batch corresponding to the broadcast stream, the generated broadcast beacon packet may be among a plurality of generated broadcast beacon packets included in the assistive beacon batch, and the per window beacon density may represent a number of generated broadcast beacon packets in the assistive beacon batch, and the beacon batch chaining interval may represent a time interval between a start of the beacon batch window and a start of a previous batch window.

In accordance with the present disclosure a broadcast transmitter may include: at least one processor configured to: receive an input configured to enable an adaptive broadcast mode of the broadcast transmitter, based on the received input, determine an optimal Quality of Service (QoS) range in which the broadcast transmitter is able to transmit data to a receiver without data loss and position information of the broadcast transmitter, generate a broadcast beacon packet correlated to a main broadcast packet and embedded with the determined optimal QoS range, the determined position information, a broadcast stream identifier, and time synchronization information, generate an assistive beacon batch corresponding to a broadcast stream, the assistive beacon batch including the generated broadcast beacon packet, based on at least one of a total number of active broadcast streams, window length information, and channel map information, determine an unused broadcast channel from among a plurality of broadcast channels of the broadcast transmitter, a beacon batch window, a per window beacon density, or a beacon batch chaining interval, schedule the assistive beacon batch to be transmitted based on the determined unused broadcast channel, the determined beacon batch window, the determined per window beacon density, or the determined beacon batch chaining time interval, and transmit the scheduled assistive beacon batch by interleaving the scheduled assistive beacon batch with an adaptive broadcast stream.

In accordance with the present disclosure a method of adaptive wireless broadcast communication may include: receiving, by a broadcast receiver, an adaptive broadcast stream including an assistive beacon batch, the assistive beacon batch including a broadcast beacon packet correlated to a main broadcast packet; identifying an adaptive broadcast mode being enabled based on adaptive wireless broadcast support information included in the received adaptive broadcast stream; periodically sniffing a predetermined number of assistive beacon batches among a plurality of assistive beacon batches for an interval of time; extracting a broadcast stream identifier from the received adaptive broadcast stream; determining an occurrence of an adaptive broadcast transmission by matching the extracted broadcast stream identifier with a required broadcast stream identifier; extracting an optimal Quality of Service (QoS) range in which a broadcast transmitter is able to transmit data to the broadcast receiver without data loss, position information of the broadcast transmitter, the broadcast stream identifier, and time synchronization information from the broadcast beacon packet included in the received adaptive broadcast stream; determining periodically whether the extracted optimal QoS range is within a distance between the broadcast receiver and the broadcast transmitter; and based on the extracted optimal QoS range being determined to be within the distance, tuning the broadcast receiver to receive the adaptive broadcast stream.

The method may further include: storing the extracted optimal QoS range, the extracted position information, the extracted broadcast stream identifier, and the extracted time synchronization information.

According to another embodiment, a broadcast receiver for adaptive wireless broadcast communication is disclosed. The broadcast receiver includes one or more processors configured to receive, from a broadcast transmitter, the one or more main adaptive broadcast streams including one or more assistive beacon batches, wherein each of the one or more assistive beacon batches includes one or more correlated broadcast beacon packets. Further, the one or more processors configured to identify an enablement of the adaptive broadcast mode based on an adaptive wireless broadcast support information included in the one or more main adaptive broadcast streams. The one or more processors are further configured to periodically sniff a predetermined number assistive beacon batches among the one or more assistive beacon batches for a predefined interval of time. The one or more processors are further configured to extract a broadcast stream identifier from the one or more main adaptive broadcast streams and determine an occurrence of an adaptive broadcast transmission by matching the broadcast stream identifier with a required broadcast stream identifier. The one or more processors are further configured to extract an optimal Quality of Service (QoS) range, position information, the broadcast stream identifier, and time synchronization information from the one or more correlated broadcast beacon packets. Further, one or more processors are configured to determine periodically whether the optimal QoS range is within a distance between the broadcast receiver and the broadcast transmitter and tuning the broadcast receiver for receiving a main adaptive broadcast stream among the one or more main adaptive broadcast streams based on a result of periodic determination that the optimal QoS range is within the distance.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an example of an adaptive wireless broadcast communication implemented in a communication system, according to an embodiment of the present disclosure;

FIG. 2 illustrates an exemplary general architecture of the broadcast transmitter and the broadcast receiver according to an embodiment of the present disclosure;

FIG. 3 illustrates a high-level architecture of the system of FIG. 2, according to an embodiment of the present disclosure;

FIG. 4 illustrates an operational flow of the broadcast transmitter 101, according to an embodiment of the present disclosure;

FIG. 5 illustrates a flow chart of the operation flow of FIG. 4, according to an embodiment of the present disclosure;

FIG. 6 illustrates a packet structure of main broadcast packet and correlated broadcast beacon packets, according to an embodiment of the present disclosure;

FIG. 7 illustrates a synchronized transmission of the assistive beacon batches with the main adaptive broadcast stream, according to an embodiment of the present disclosure;

FIG. 8 illustrates an adaptive beacon chaining scheme, according to an embodiment of the present disclosure;

FIG. 9 illustrates an example of the adaptive beacon batch tear-down and synchronization with a main broadcast stream, according to an embodiment of the present disclosure;

FIG. 10 illustrates an operational flow of the broadcast receiver 101, according to an embodiment of the present disclosure;

FIG. 11 illustrates a flow chart of the operation flow of FIG. 10, according to an embodiment of the present disclosure;

FIG. 12 illustrates an adaptive beacon batch sniffing in the adaptive beacon batch sniffing window, according to an embodiment of the present disclosure; and

FIG. 13 to FIG. 18 illustrate various example scenarios, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

According to an embodiment, the present disclosure discloses a method and a system for configuring an optimal range-assisted adaptive wireless broadcast communication. According to an embodiment, the system disclosed herein dynamically determines real-time position information and the best quality reception range (i.e., an optimal quality of service (QoS) range) of a broadcast transmitter. The system further generates one or more correlated broadcast beacon packets embedded with determined real-time position information along with a broadcast stream identifier, and time synchronization information. The system further generates chains of assistive beacon batches including the generated one or more correlated broadcast beacon packets. The system further transmits the assistive beacon batches by interleaving with one or more main adaptive broadcast streams by scheduling the one or more assistive beacon batches based on one or more least unused broadcast channels, a beacon batch window, a per window beacon density, and a beacon batch chaining time interval. According to a further embodiment, a broadcast receiver extracts the position information and QoS range from the main adaptive broadcast streams. The receiver further determines an optimal position of the broadcast transmitter with reference to self-position and co-relates this information with the extracted position information, the QoS range information to further determine the best quality reception region for the multi-stream broadcast contents.

The detailed methodology and architecture are explained in the following paragraphs.

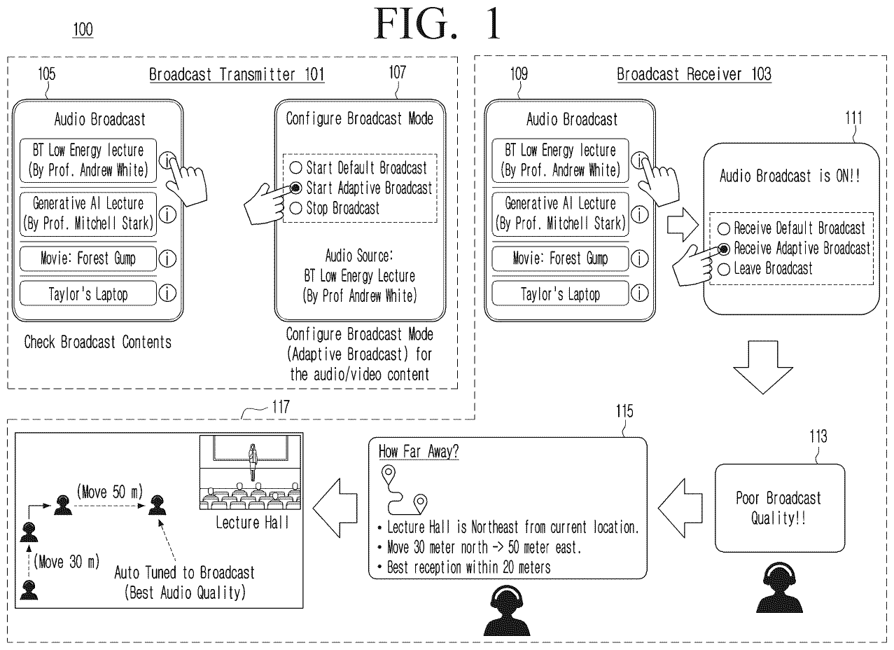

FIG. 1 illustrates an example of an adaptive wireless broadcast communication implemented in a communication system, according to an embodiment of the present disclosure. The communication system 100 as depicted includes a broadcast transmitter 101 communicates with one or more broadcast receivers 103. As an example, the broadcast transmitter 101 may include, but are not limited to, a smart television (TV), a smartphone, a smart home device, and the like. Further, the broadcast receiver 103 may include but is not limited to, a wireless headset, earbuds, ear pods, the smart television (TV), the smartphone, or any electronic device capable of receiving audio/video content. Further, according to the illustration only a single broadcast receiver is shown, however, there can be more than one broadcast receiver. Furthermore, the broadcast transmitter 101 may be alternately referred to as transmitter 101, and the broadcast receiver 103 may be alternately referred to as a receiver 103 throughout the disclosure. Further, the audio/video content may be alternately referred to as broadcast content throughout the disclosure.

According to an embodiment, initially, at block 105, a user at the broadcast transmitter 101 may select one broadcast content from an available broadcast content for adaptively broadcasting the selected broadcast content. Further, at block 107, the user may enable adaptive broadcast mode in the broadcast transmitter 101, by selecting an appropriate icon. Further, at block 109, the user at the broadcast receiver 103 may select an appropriate icon to receive the broadcast content from the broadcast transmitter 101. Further, the user may enable the adaptive broadcast mode in the broadcast receiver 103, by selecting an appropriate icon for adaptively receiving the broadcast content. As shown in the example embodiment, during the adaptive reception of the broadcast content, consider that a quality of the broadcast content received by the broadcast receiver 103 is of poor quality as depicted at block 113. In an example embodiment, the broadcast receiver 103 may autotune the broadcast receiver 103 with a best quality reception of the broadcast content by guiding the user of the broadcast receiver 103 to move at a position where an optimal QoS range can be received. According to an embodiment, the broadcast receiver 103 extracts the optimal QoS range, the position information, the broadcast stream identifier, and the time synchronization information from the one or more correlated broadcast beacon packets sent in the main adaptive broadcast stream by the broadcast transmitter 101.

According to some embodiment, the broadcast transmitter 101 and the broadcast receiver 103 may saves a user profile information which can be further auto-suggested to the user next time, when the user selects to broadcast similar content.

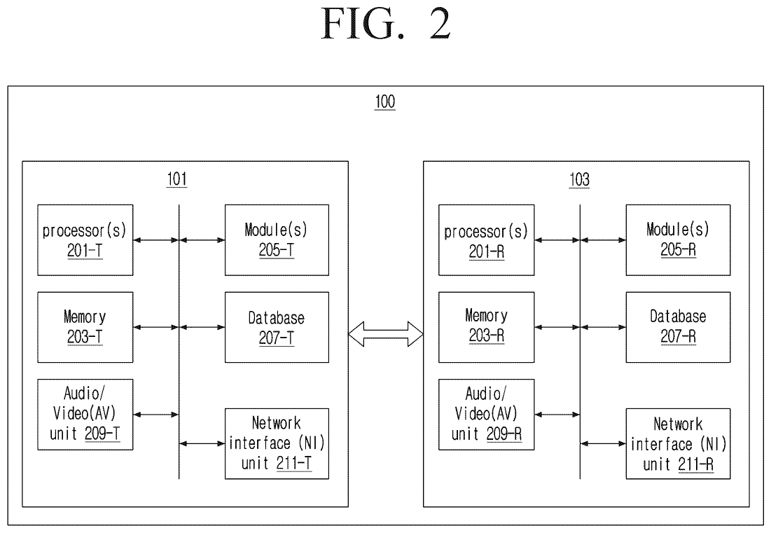

FIG. 2 illustrates an exemplary architecture of the broadcast transmitter 101 and the broadcast receiver 103 according to an embodiment of the present disclosure. The broadcast transmitter 101 includes a processor(s) 201-T, a memory 203-T, a module(s) 205-T, a database 207-T, an Audio/Video (AV) unit 209-T, and a network interface (NI) 211-T coupled with each other. Further, the broadcast receiver 103 includes a processor(s) 201-R, a memory 203-R, module(s) 205-R, a database 207-R, an Audio/Video (AV) unit 209-R, and a network interface (NI) 211-R coupled with each other.

In an embodiment, the database 207-T and the database 207-R can be collectively referred to as a database 207. Further, the module(s) 205-T and the module(s) 205-R may be collectively referred to as modules and as when applicable in the present disclosure.

For example, the processor 201-T and the processor 201-R may be a single processing unit or a number of units, all of which could include multiple computing units. The processor 201-T and the processor 201-R may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201-T and the processor 201-R are configured to fetch and execute computer-readable instructions and data stored in the memory 203-T and the memory 201-R respectively.

The memory 203-T and the memory 201-R may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

As an example, the module(s) 205-T and the module(s) 205-R may include a program, a subroutine, a portion of a program, a software component, or a hardware component capable of performing a stated task or function. As used herein, the module(s) 205-T and the module(s) 205-R may be implemented on a hardware component such as a server independently of other modules, or a module can exist with other modules on the same server, or within the same program. The module(s) 205-T and the module(s) 205-R may be implemented on a hardware component such as processor one or more microprocessors, microcomputers, microcontrollers, digital signal processors, central processing units, state machines, logic circuitries, and/or any devices that manipulate signals based on operational instructions. The module(s) 205-T and the module(s) 205-R when executed by the processor 201-T and the processor 201-R respectively may be configured to perform any of the described functionalities.

As a further example, the database 207-T and the database 207-R may be implemented with integrated hardware and software. The hardware may include a hardware disk controller with programmable search capabilities or a software system running on general-purpose hardware. The examples of the database 207-T and the database 207-R include but are not limited to, in-memory databases, cloud databases, distributed databases, embedded databases, and the like. The database 207-T and the database 207-R, amongst other things, serve as a repository for storing data processed, received, and generated by one or more of the processors, and the modules/engines/units.

In an embodiment, the module(s) 205-T and the module(s) 205-R may be implemented using one or more AI modules that may include a plurality of neural network layers. Examples of neural networks include but are not limited to, Convolutional Neural Network (CNN), Deep Neural Network (DNN), Recurrent Neural Network (RNN), and Restricted Boltzmann Machine (RBM). Further, ‘learning’ may be referred to in the disclosure as a method for training a predetermined target device (for example, a robot) using a plurality of learning data to cause, allow, or control the target device to decide or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with an AI module may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning.

As an example, the AV unit 209-T transmits the audio/video content as the broadcast content to the broadcast receiver 103. As a further example, the AV unit 209-R receives the audio/video content as the broadcast content from the broadcast transmitter 101. As a further example, the NI unit 211-T and the NI unit 211-R establish a network connection with a network like a home network, a public network, a private network, broadcast transmitter 101, or the broadcast receiver 103 the like.

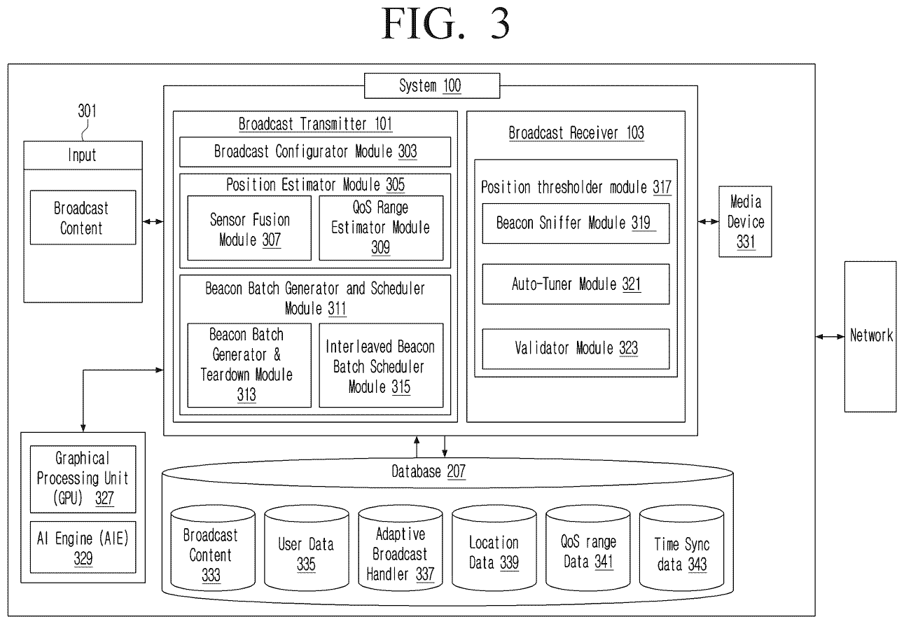

FIG. 3 illustrates a high-level architecture of the system of FIG. 2, according to an embodiment of the present disclosure. In an embodiment, the module(s) 205-T of the broadcast transmitter 101 of the system 100 further includes a broadcast configurator module 303, a position estimator module 305, and a beacon batch generator and scheduler module 311 are coupled and collectively operates with each other. The position estimator module 309 further includes a sensor fusion module 307 and a QoS range estimator module 309. The beacon batch generator and scheduler module 311 further includes a beacon batch generator and teardown module 313 and an interleaved beacon batch scheduler module 315.

According to a further embodiment, the broadcast receiver 103 includes a position thresholder module 317 that further includes a beacon sniffer module 319, an auto-tuner module 321, and a validator module 323. In a further embodiment, the system 100 is further coupled with an Artificial Intelligence (AI) engine 329, a graphical processing unit (GPU) 327, the database 207, and a media device 331. According to some embodiment, the Artificial Intelligence (AI) engine 329, and the graphical processing unit (GPU) 327 may be implemented within the broadcast transmitter 101 and the broadcast receiver 103.

According to an embodiment, various functions of the module(s) 205-T and module(s) 205-R can be performed by the processor 201-T and the processor-R of FIG. 2. However, for ease of understanding, an explanation is provided with respect to various modules. In embodiment module(s) may be a set of instructions that may be stored in memory. The processor executes the set of instructions thereby operating these modules.

According to an embodiment, the database 207 further includes broadcast content 333 includes data related to the broadcast content, a user data 335 includes data related to the user using the broadcast transmitter 101 or the broadcast receiver 103, an adaptive broadcast handler 337 handles the adaptive broadcast transmission, a location data 339 includes data related to the position information, QoS range data 341 includes data related to estimated QoS range, and a time sync data 343 includes data related to time synchronization information.

According to an embodiment, the media devices 331 include at least a display, a graphical user interface (GUI), and a camera for displaying user interface via the media devices 331. A brief working of each of the modules will be described in the forthcoming paragraphs.

According to an embodiment, the broadcast configurator module 303 enables the adaptive wireless broadcast mode in the broadcast transmitter 101. As shown in FIG. 1 at block 107, the user selects the appropriate icon to enable the adaptive wireless broadcast mode. In an embodiment, if the adaptive broadcast mode is enabled, the broadcaster transmitter 101 will have the option to select and start broadcast contents in the adaptive broadcast mode.

According to an embodiment, the broadcast transmitter 101 further has a default broadcast mode. However, the adaptive broadcast mode is different from the default broadcast mode. According to an embodiment, the default broadcast mode immediately starts broadcasting the selected stream with no additional processing. This is the existing mode of starting wireless broadcast transmission which does not contain any spatial awareness information embedded into the broadcast stream. The broadcast stream merely includes real broadcast data scheduled over a wireless channel in accordance with the state-of-the-art method.

According to an embodiment, the broadcast transmitter 101 receives the broadcast content 301 for transmission. According to an embodiment, the broadcast transmitter 101 when transmitting the broadcast content in the adaptive broadcast mode, includes spatial awareness information like the optimal QoS range, the position information, the broadcast stream identifier, and time synchronization information. The spatial awareness information is then embedded into the one or more correlated broadcast beacon packets and then included in one or more assistive beacon batches.

The one or more assistive beacon batches are concurrently scheduled by the broadcast transmitter 101 having the spatial awareness information. Thus, the spatial awareness information ensures the best QoS for the broadcast receivers that intend to receive the broadcast contents.

According to a further embodiment, the position estimator module 305 determines the optimal QoS range of the broadcast contents with respect to a change in a position of the broadcast transmitter 101. In an embodiment, to determine the optimal QoS range of the broadcast contents, the position estimator module 305 uses the sensor fusion module 307 that determines the change in the position of the broadcast transmitter periodically. The results and output of the sensor fusion module 307 are then used by the QoS range estimator module 309 that determines the best quality reception range with respect to the change in the position of the broadcast transmitter 101.

According to a further embodiment, the beacon batch generator & teardown module 313, of the beacon batch generator and scheduler module 311, generates per-stream assistive broadcast beacon batch embedded with the spatial awareness information. Further, the interleaved beacon batch scheduler module 315, of the beacon batch generator and scheduler module 311, schedules the assistive broadcast beacon batches, by interleaving the assistive beacon batches based on the one or more least unused broadcast channels, the beacon batch window, the per window beacon density, and the beacon batch chaining time interval.

According to an embodiment, the beacon batch window represents a time period of transmitting a single assistive beacon batch corresponding to each of the broadcast streams. Further, the per window beacon density represents a number of correlated broadcast beacon packets in the single assistive beacon batch. Furthermore, the beacon batch chaining interval represents a time interval between a start of the beacon batch window and a start of a previous batch window.

According to a further embodiment, the position thresholder module 317, at the broadcast receiver 103, determines the QoS range assisted target navigation path. Further, the beacon sniffer module 319, of the position thresholder module 317, sniffs the adaptive main broadcast streams and thereby extracts the spatial awareness information to obtain the best quality of QoS range estimates in a time synchronized fashion. Further, the auto-tuner module 321, of the position thresholder module 317, estimates the optimal QoS range based on the spatial awareness information for tuning the broadcast receiver 103 automatically for getting the optimal reception quality. Furthermore, validator module 323, of the position thresholder module 317, latches on to the main adaptive broadcast stream, upon satisfying the determined optimal QoS range estimates.

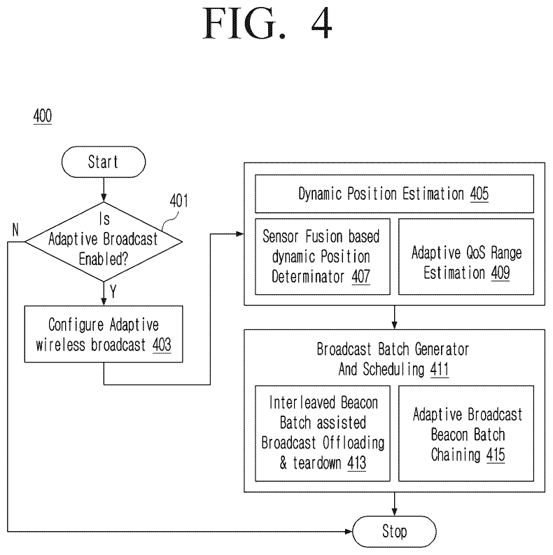

A detailed working, and explanation of the various modules of FIG. 3 in the broadcast transmitter 101 and broadcast receiver 103 will be explained in detail through FIG. 4 to FIG. 9 in the forthcoming paragraphs.

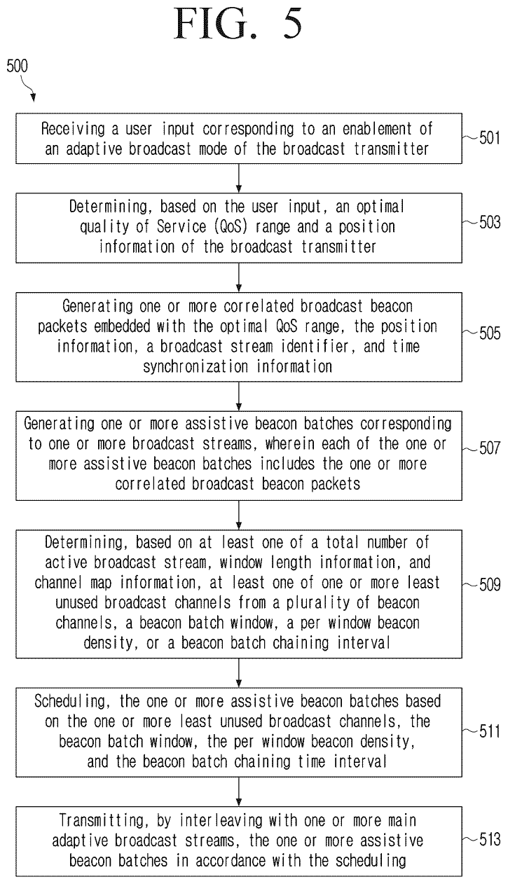

FIG. 4 illustrates an operational flow of the broadcast transmitter 101, according to an embodiment of the present disclosure. The operation flow 400 is implemented in the broadcast transmitter 101 and will be explained through various operation steps 401 to 415. Further, FIG. 5 illustrates a flow chart of the operation flow 500 and hence will be explained collectively with the operation flow 400 for the sake of brevity and ease of reference. Accordingly, an explanation of the operation flow 400 will be explained in the forthcoming paragraphs and through FIG. 1 to FIG. 9. Further, the reference numerals were kept the same for the similar components throughout the disclosure for ease of explanation and understanding.

According to an embodiment, if the adaptive broadcast mode is supported by the broadcast transmitter 101 then, the adaptive broadcast transmitter will have an option to select and start broadcast contents in the adaptive broadcast mode. According to an embodiment, the user selects the adaptive broadcast model for a selected broadcast stream. The enablement of the adaptive broadcast mode and selection of the broadcast content is shown in FIG. 1 at blocks 105 and 107. According to an embodiment, a broadcast handler requests the adaptive broadcast handler 337 to triggers the adaptive broadcast. Accordingly, at step 401, the broadcast configurator module 303 checks whether the adaptive broadcast mode is enabled. Based on the user input corresponding to the selection of the adaptive broadcast mode, the broadcast configurator module 303, at step 403 enables the adaptive broadcast mode. Further, the broadcast configurator module 303 enables the adaptive broadcast support by setting ‘1’ to adaptive broadcast support bit of a main broadcast packet. According to an embodiment, step 403 corresponds to step 501 of FIG. 5.

In an embodiment, as the adaptive broadcast mode is enabled, the broadcast transmitter 101 may receive a list of audio broadcast contents for transmitting different broadcast streams to different broadcast receivers.

Further, the position estimator module 305 determines the QoS range and the position information of the broadcast transmitter 101 at periodic intervals at block 405. The operation 405 includes a sensor fusion based dynamic position determinator 407 operation is performed by the sensor fusion module 307 and an adaptive QoS range estimation 409 operation is performed by the QoS range estimator module 309. The operations 407 and 409 will be explained in detail in the following paragraphs.

Accordingly, at first to determine the position information of the broadcast transmitter 101, the sensor fusion module 307 periodically monitors a position of the broadcast transmitter 101. The purpose of monitoring periodically the position of the broadcast transmitter 101 is to determine the dynamic displacement of the broadcast transmitter 101 with respect to time. The displacement of the broadcast transmitter 101 is a trigger point for positioning and further starting the QoS range estimation. According to an example embodiment, the periodic position of the broadcast transmitter 101 may be received from various sensors like a accelerometer sensor. In a non-limiting example, the accelerometer sensor may send 3-axis accelerometer data as acceleration data. Further, a global positioning service (GPS) sensor sends GPS data periodically to the sensor fusion module 307.

According to an embodiment, the periodic displacement of the broadcast transmitter 101 and the position information are sent to the sensor fusion module 307. In an embodiment, the sensor fusion module 307 determines the position information based on the acceleration data and the GPS data.

According to some embodiments, the sensor fusion module 307 determines the position information based on indoor localization method. Further, the sensor fusion module 307 determines the position information by using various several IPS systems like trilateration using anchor & tag based, BLE RSSI finger printing based, Wi-Fi RTT based, UWB based etc.

According to some embodiment, the sensor fusion module 307 further determines an updated position information with respect to a change in the position of the broadcast transmitter 101 within a predefined time interval. According to an embodiment, it is one of the important aspects of the disclosed technique to obtain an updated position information of the broadcast transmitter 101 for providing the best quality reception of the broadcast content. In a non-limiting example, a sensor fusion technique may be utilized by combining the acceleration data and the GPS data over time for the determination of the updated position of the broadcast transmitter 101.

According to an embodiment, the sensor fusion module 307 registers a function to recursively calculate the position of the broadcast transmitter 101 in regular intervals. As an example, the regular intervals may be considered as 3 seconds as it is assumed, that the broadcast transmitter 101 may not be a continuously moving device. Hence, an interval of 3 seconds is sufficient to determine the position of the broadcast transmitter 101. Further, the sensor fusion module 307 determines a starting point (let's say ‘A”) of the broadcast transmitter 101. In an embodiment, the sensor fusion module 307 uses a Kalman filter based sensor fusion model to accurately determine the position of the broadcaster at the regular interval. The Kalman filter based sensor fusion model takes the acceleration data and the GPS data to regularly output with accuracy the position information of the starting point. In an embodiment, the regular interval may be maintained by a timer. Further, as the timer expires a new position is calculated.

According to an embodiment, the sensor fusion module 307 monitors periodically the position of the broadcast transmitter 101. Further, the sensor fusion module 307 determines, within a predefined time interval, an updated position information with respect to the change in the position of the broadcast transmitter 101 based on a result of the monitoring. According to an embodiment, as the sensor fusion module 307 monitors periodically the position of the broadcast transmitter 101, thus the sensor fusion module 307 periodically receives the acceleration data and the GPS. Accordingly, the sensor fusion module 307 determines the updated position information with respect to the change in the position of the broadcast transmitter based on the acceleration data and the GPS data. In an embodiment, the updated position information is a position information of the broadcast transmitter 101 with respect to an immediate previous position of the broadcast transmitter 101. For example, consider that the broadcast transmitter 101 is at position ‘A’ at an instance then it moves to position ‘B’ after a certain period of time. Then the position information is updated with respect to the position ‘A’.

The forthcoming paragraphs explain the mathematical operations involved in the determination of the updated position.

According to an embodiment, the acceleration data (a) may be calculated based on equation 1.

$$a = dv / dt \qquad ( 1 )$$

where dv is the change of velocity in time dt.

According to an embodiment, a velocity v_{A} at interval t_{A} is an integral acceleration, expressed as the equation of the line, with respect to time and given by equation 2.

$${{v}_{A} - {v}_{0} = {\int }_{0}^{{t}_{A}} \frac{{a}_{A}}{{t}_{A}} t dt = \frac{{a}_{A}}{{t}_{A}} \frac{{t}^{2}}{2} ]}_{0}^{{t}_{A}} equates to {v}_{A} = \frac{{a}_{A} {t}_{A}}{2} \qquad ( 2 )$$

Further, the displacement x_{A} at interval t_{A} is an integral of the velocity, expressed as the equation of the line, with respect to time and given by equation 3.

$${{x}_{A} - 0 = {\int }_{0}^{{t}_{A}} \frac{{a}_{A}}{2} t dt = \frac{{a}_{A}}{2} \frac{{t}^{2}}{2} ]}_{0}^{{t}_{A}} equates to {x}_{A} = \frac{{a}_{A} {t}_{A}^{2}}{4} \qquad ( 3 )$$

Further, a velocity v_{B} at interval t_{B} is the integral acceleration, expressed as the equation of the line, with respect to time and given by equation 4.

$${v}_{0} - {v}_{A} = {\int }_{{t}_{A}}^{{t}_{B}} [ \frac{{a}_{B} - {a}_{A}}{{t}_{A}} t + ( 2 {a}_{A} - {a}_{B} ) ] dt , equates to , {v}_{R} - {v}_{A} = \frac{1}{2} {t}_{A} ( {a}_{B} + {a}_{A} ) \qquad ( 4 )$$

Further, displacement at interval is the integral velocity and is expressed as the equation of the line, with respect to time, and given by equation 5.

$${x}_{B} - {x}_{A} = {\int }_{{t}_{A}}^{{t}_{B}} [ \frac{{v}_{0} - {v}_{A}}{{t}_{B} - {t}_{A}} t + ( 2 {v}_{A} - {v}_{B} ) ] dt , equates to , {x}_{B} = \frac{1}{2} {t}_{A} ( {v}_{B} + {v}_{A} ) \qquad ( 5 )$$

According to an embodiment, equation 5 can be further reduced to equation 6 where the present position is the summation of the previous position, integral of velocity, and the double integration of the acceleration.

$${\vec{x}}_{t} = {\vec{x}}_{t - 1} + {{\int }^{t}}_{t - 1} \dot{\vec{x}} dt + {{\int }^{t}}_{t - 1} ( {{\int }^{t}}_{t - 1} x dt ) dt , \qquad ( 6 )$$

According to a further embodiment, a GPS receiver (not shown) may be implemented in the broadcast transmitter 101 for determining position based on the GPS data. The GPS receiver determines the position of the broadcast transmitter 101 by calculating a geometric intersection of ranges of known coordinates of the satellites and the GPS receiver using equation 7.

$${ρ}_{c}^{( k )} = \sqrt{{( {x}^{( k )} - x )}^{2} + {( {y}^{( k ) - y} )}^{2} + {( {z}^{( k )} - z )}^{2}} + b + {\overline{s}}_{ρ}^{( k )} , \qquad ( 7 )$$

Further, according to an embodiment, in some cases the position and orientation of the accelerometer sensors may be contaminated by the double integration errors of the low-cost accelerometer. Therefore, such errors are further overcome by fusing both the sensor data with an appropriate filter, like the Kalman filter.

Accordingly, after determining measurement errors and the position information, the data were fed to the Kalman filter model. Then the position information is updated with the Kalman filter-derived accelerometer information using equation 8, where A denotes the accelerometer sensor and G denotes for GPS sensor.

$$\begin{matrix}{\vec{x}}_{t} = {\vec{x}}_{t - 1} + ( {\dot{\vec{x}}}_{t - 1}^{G} * Δ t ) + ( \frac{1}{2} {\vec{x}}_{t}^{A} * {( Δ t )}^{2} ) + \\ ( ( \frac{1}{2} {\vec{x}}_{t - 1}^{G} * {( Δ t )}^{2} ) - ( \frac{1}{2} {\vec{x}}_{t - 1}^{A} * {( Δ t )}^{2} ) ) .\end{matrix} \qquad ( 8 )$$

To this end, the position information and the updated position information are being determined by the sensor fusion module 307. In the following paragraphs, the optimal QoS range estimation will be explained.

For the efficient working of any wireless communication device, an operating range depends on the maximum distance between a transmitter and a receiver. Accordingly, an optimal QoS range is required to be obtained so that the broadcast receiver 103 receives the best reception quality. However, there are many factors affecting the QoS range, that typically depend on the following factors such as the output power of the transmitter, the sensitivity of the receiver, physical obstacles in a transmission path, an antenna gain, etc.

According to an embodiment, the QoS range estimator module 309 determines the optimal QoS with respect to the change in the position of the broadcast transmitter by monitoring a plurality of sensor parameters of the broadcast transmitter. In a non-limiting example, the plurality of sensor parameters includes at least one of the output power of the broadcast transmitter 101, a sensitivity of the broadcast receiver 103, the physical obstacles in the transmission path between the broadcast transmitter 101 and one or more the broadcast receivers, and the antenna gain obtained from the plurality of sensors. Further, the QoS range estimator module 309 determines a path loss based on a result of the monitoring of the plurality of sensor parameters. Further, the QoS range estimator module 309 determines the optimal QoS with respect to the change in the position of the broadcast transmitter based on the path loss. Accordingly, QoS range estimator module 309 estimates the QoS range using equation 9.

$$QoS Range ( km ) = {10}^{( maximum path loss - 32.44 - 20 log ( f ) ) / 20 )} \qquad ( 9 )$$

According to some embodiment, the QoS range may be taken as an input from user, while configuring the adaptive wireless broadcast transmitter or broadcast receiver. Accordingly, the user set QoS range may over-ride the QoS range determined by the QoS range estimator module 309.

According to an embodiment, as the broadcast transmitter 101 updates its position, the QoS range estimator module 309 updates the QoS range based on the updated position information.

According to an embodiment, the optimal QoS range and the position information are embedded in the broadcast beacon packets. According to some embodiment, the optimal QoS range and the position information can be embedded in the assistive broadcast beacon batches. The following paragraphs will explain the generation of the broadcast beacon packets.

The wireless broadcast is a collection of one or multiple broadcast streams which are started by the user. These broadcast streams are scheduled by a broadcast scheduler. The RF layer picks up the broadcast streams and schedules them over the air in a FIFO fashion. Further, the broadcast streams can be run simultaneously over time. Furthermore, each broadcast stream is mutually exclusive from other broadcast streams.

According to an embodiment, the beacon batch generator and scheduler module 311 generate one or more adaptive broadcast beacon packets (ABBPs). One or more adaptive beacon packets may be alternately referred to as correlated broadcast beacon packets or one or more correlated broadcast beacon packets or adaptive beacon packets throughout the disclosure. According to an embodiment, the correlated broadcast beacon packets are a co-relation packet which is an optimized assistive off-loader of the main adaptive broadcast stream. The main purpose of generating the correlated broadcast beacon packets is to offload the main adaptive broadcast stream of too many packet overheads. Accordingly, the broadcast receivers 103 are offloaded from checking each broadcast stream packet for adaptive broadcast information. Further, the broadcast receivers 103 can prioritize the processing of payloads or data included in the main adaptive broadcast stream. According to an embodiment, the broadcast receiver 103 only sniffs the correlated broadcast beacon packets during a given time slot for extracting critical information like the position information and the QoS range of the broadcast transmitter 101.

Referring back to FIG. 4 and FIG. 5, at block 411, the beacon batch generator and scheduler module 311 perform a generation of the beacon batches and schedule the same. Accordingly, at step 505, the beacon batch generator and scheduler module 311 generates one or more correlated broadcast beacon packets embedded with the optimal QoS range, the position information, a broadcast stream identifier, and time synchronization information. In an embodiment, the one or more correlated broadcast beacon packets are generated by the broadcast scheduler on receiving a command from the adaptive broadcast handler 337.

According to an embodiment, the one or more correlated broadcast beacon packets are unique packets where each stream is uniquely identified by the broadcast stream identifier (ID). The broadcast stream identifier may be alternately referred to as a stream ID. These broadcast stream identifiers for each stream help in uniquely identifying the broadcast streams in the broadcast receiver 103 side. Further, the one or more correlated broadcast beacon packets are synchronized in accordance with the time sync information and scheduling.

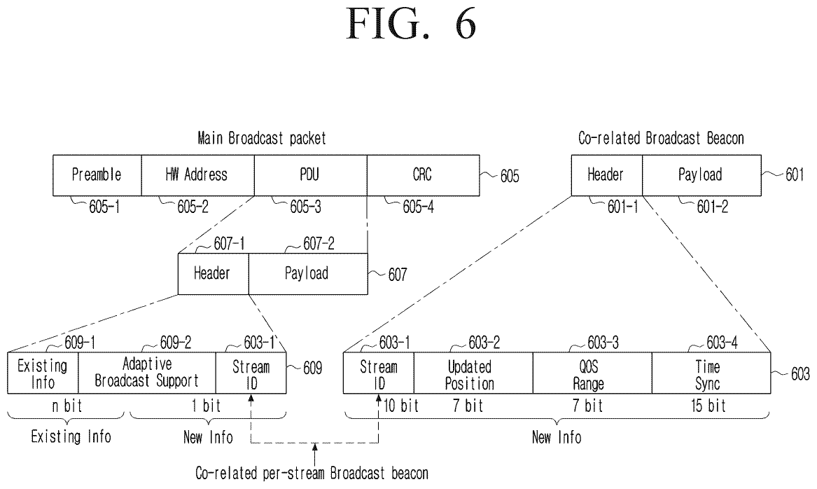

FIG. 6 illustrates a packet structure of the main broadcast packet and correlated broadcast beacon packets, according to an embodiment of the present disclosure. As can be seen, the correlated broadcast beacon packet 601 includes a header 601-1 and a payload 601-2. In an embodiment, the header 601-1 further includes various fields such as the stream ID 603-1 of 10 bit, updated position 603-2 of 7 bit (i.e. position information), the QoS range 603-3 of 7 bit, a time sync 603-4 of 15 bit. Table 1 illustrates various definitions of the header 601-1 filed. The number of bits assigned to each filed of the main broadcast packet and correlated broadcast beacon packets are variable.

TABLE 1
Stream ID: Stream ID uniquely identifies a broadcast stream.
Updated position or position information: This contains the real-time
accelerometer data and the corrected GPS location of the broadcast
content transmitter.
QOS Range: QOS range determines the best quality reception range
of the broadcast transmitter.
Time Sync: Time sync is the current local system time during which
a new position & range estimates are embedded into the broadcast streams.
This helps the broadcast receiver to schedule periodic updates of the new
updated positions & range estimates.

### Table 1

According to a further embodiment, the main broadcast packet 605 includes various fields such as a preamble 605-1, a hardware (HW) address 605-2, a packet data unit (PDU) 605-3, and a cyclic redundancy check (CRC) 605-4. Further, the PDU 605-3 includes a header 607-1 and a payload 607-2. In an embodiment, the header 607-1 further includes existing info 609-1 of n bit, an adaptive broadcast support 609-2 of 1 bit value indicates adaptive support information which indicates whether the adaptive broadcast mode is enabled in the stream or not, and the stream ID 603-1 is indicative of the broadcast stream that is broadcasted via the one or more main adaptive broadcast streams. Table 2 illustrates various definitions of fields of the main broadcast packet. As can be seen, only the stream ID is being transmitter in the broadcast packet to avoid the overhead. The stream ID maintains a co-relation between the actual stream i.e. the mainstream and the adaptive information i.e. the embedded information in the adaptive broadcast support 609-2.

TABLE 2
Preamble: The preamble is a preliminary data bits of the NW layer packet
HW address: The HW address is equivalent to a physical device address
(Example: Bluetooth Device Address or physical MAC address). It
uniquely identifies a physical device.
PDU: The PDU stands for packet data unit, basically a unit packet data
structure.
CRC: The CRC stands for cyclic redundancy check. A cyclic redundancy
check (CRC) is an error detecting code commonly used in digital networks
and storage devices to detect accidental changes to digital data.
Header: The header identifies the type of the packet. It generally contains
information about the data type or payload type.
Payload: The payload is the actual user data contained in any network
packet.

According to some embodiment, a broadcast timeout may be added to the Adaptive broadcast payload information. On expiry of this timer, the adaptive broadcast may switch to a default wireless broadcast automatically.

Referring back to FIG. 5, at step 507, the beacon batch generator and scheduler module 311 generate one or more assistive beacon batches corresponding to one or more broadcast streams. According to an embodiment, each of the one or more assistive beacon batches includes the one or more correlated broadcast beacon packets. According to some embodiment, the optimal QoS range and the position information can be embedded in the assistive broadcast beacon batches.

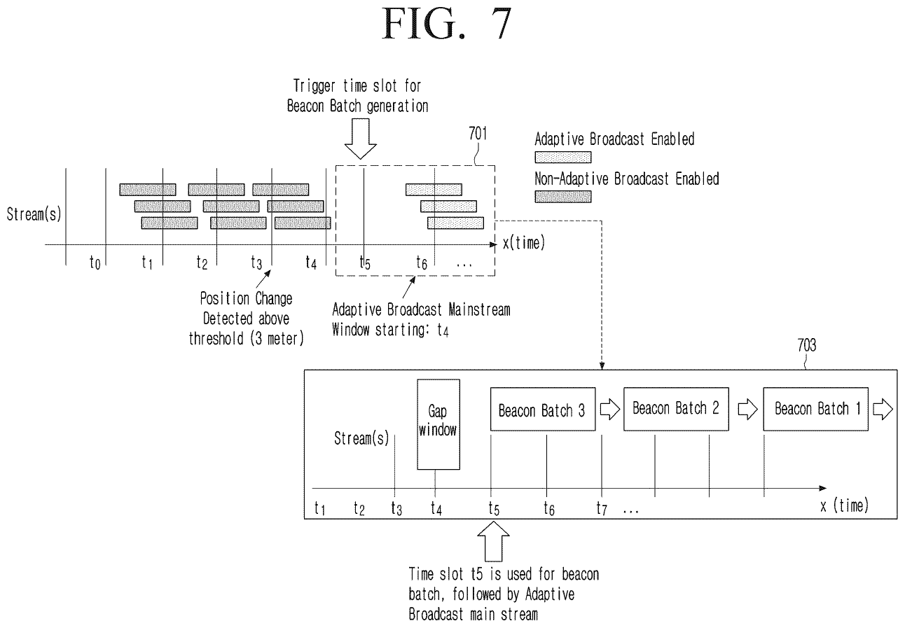

FIG. 7 illustrates a synchronized transmission of the assistive beacon batches with the main adaptive broadcast stream, according to an embodiment of the present disclosure. As explained in above paragraphs, the position estimator module 305, maintains the timer for periodically monitoring the change in position of the broadcast transmitter 101. Consider that at time t3 the position change is detected. This triggers a time slot for the assistive beacon batch generation. As can be seen at block 701, from t4 the adaptive broadcast main stream window commences. Further, as shown in the block 703, the time slot T5 is used for assistive beacon batch transmission. According to an embodiment, the assistive beacon batches, having embedded with the optimal QoS range, the position information, a broadcast stream identifier, and time synchronization information, are transmitted in an interleaved fashion along with the main adaptive broadcast stream in accordance with the scheduling of the assistive beacon batches.

According to further embodiment, the beacon batch generator and scheduler module 311 further updates the one or more assistive beacon batches by embedding each assistive beacon batch with the updated position information of the broadcast transmitter 101, when there is a change in the position of the broadcast transmitter. In an embodiment, the updated position information is updated in the one or more correlated broadcast beacon packets.

According to an embodiment, the one or more assistive beacon batches are scheduled before the onset of transmission of the one or more main adaptive broadcast streams. In an embodiment, the immediate timeslot after starting the adaptive wireless broadcast will be consumed by the adaptive beacon batch transmission. The transmission of the one or more correlated broadcast beacon packets starts at an immediate time slot after the enablement of the adaptive broadcast mode. Thus, the main adaptive broadcast stream resumes after 1 Timeslot gap (˜150-300 microseconds).

According to an embodiment, scheduling logic for the assistive beacon batch is critical in order to obtain optimized processing and minimal overhead to the broadcast receiver 103. This is achieved by implementing a unique adaptive broadcast beacon batch chaining 415 approaches performed by the interleaved beacon batch scheduler module 315. According to an embodiment, each assistive beacon batch transmission is under a selected batch window and optimal window beacon density based on currently active adaptive broadcast streams. The adaptive broadcast beacon batch chaining 415 will be explained in the forthcoming paragraphs.

Referring back to FIG. 5, at step 509, the interleaved beacon batch scheduler module 315 determines at least one of one or more least unused broadcast channels from a plurality of beacon channels, a beacon batch window, a per window beacon density, or a beacon batch chaining interval based on at least one of a total number of active broadcast stream, window length information, and channel map information.

According to an embodiment, the interleaved beacon batch scheduler module 315 determines the total number of active broadcast streams, the window length information, and the channel map information. According to an embodiment, the channel map information is a bitmap indicating a number of RF Channels used for broadcast transmission. According to an embodiment, the adaptive broadcast handler 337 has the total number of active broadcast streams and the channel map information.

According to an embodiment, generally, the window length range is between 100 milliseconds˜3000 milliseconds. Further, the window length is a function of a total number of active broadcast streams ‘x’. In an embodiment, the window length is inversely proportional to x and limited between 100 milliseconds to 3000 milliseconds. The window length range is given in Equation 10.

$$range 1 < x < 1000 , x -> 100 milliseconds y = f ( x ) = > y = k / x , k = 3 \qquad ( 10 )$$

According to an embodiment, the interleaved beacon batch scheduler module 315 determines per window beacon density i.e., the number of beacons per window based on the following reasoning. As it is determined that each window length is between 100 milliseconds to 3000 milliseconds. Therefore, each packet takes ˜150 microseconds to schedule over the air. Further, if the maximum window is set then, 20,000 or 20k packets can be transferred within the window length for the given assistive beacon batch. Further, each correlated broadcast beacon packet is embedded with the time synchronization information that contains the beacon batch chaining time interval, and the time stamp of the next periodic position update value.

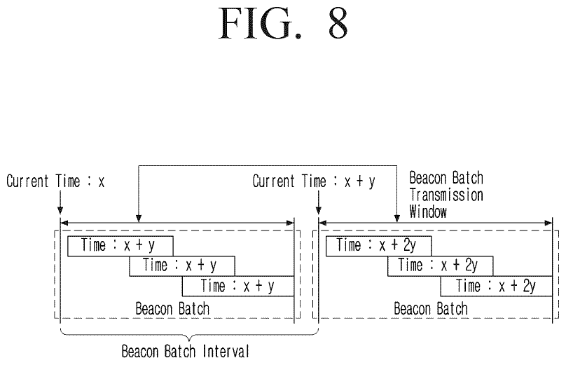

FIG. 8 illustrates an adaptive beacon chaining scheme, according to an embodiment of the present disclosure. According to an embodiment, the interleaved beacon batch scheduler module 315 determines an optimal beacon batch chaining time interval upon enabling the adaptive broadcast mode. According to an embodiment, the beacon batch interval, generally, ranges between the range of a window size and delta. The delta may be given by equation 11.

$$500 millisecond < delta < 5000 millisecond \qquad ( 11 )$$

As can be seen in FIG. 8, X represents the time when the beacon batches are transmitted and Y represents the beacon batch interval. In a non-limiting example, if the beacon batch is transmitted at time X, the next batch will be transmitted at time X+Y, the further next batch will be transmitted at time X+2Y, X+3Y, and so on.

Further, if the broadcast receiver 103 misses the assistive beacon batch in a particular window, then, it can wait for the next window. In an embodiment, the wait can be 500 milliseconds. Furthermore, if the broadcast receiver 103 receives some assistive beacon batch during the batch window, then, it can skip all other sniffing and simply wait for the next periodic update. The broadcast receiver 103 decides this based on the beacon batch chaining time interval embedded in the correlated beacon batches.

According to a further embodiment, to determine the one of one or more least unused broadcast channels, the interleaved beacon batch scheduler module 315 obtains the total number of active broadcast streams and the channels that are selected for the broadcasts from the adaptive broadcast handler 337. Further, the interleaved beacon batch scheduler module 315 discovers alternate channels for beaconing so as to avoid maximum collision with actual broadcast data. Further, the interleaved beacon batch scheduler module 315 performs bitmap OR'ing to find all the channels from the channel map information. Accordingly, the interleaved beacon batch scheduler module 315 determines whether all channels are occupied. Now if all the channels are occupied then the interleaved beacon batch scheduler module 315, generates and picks channels in pseudo-random order and further distributes beacons in a batch in those unused channels. Thus, the interleaved beacon batch scheduler module 315 schedules the beacon batch in the least used or free channels as much as possible.

Referring back to FIG. 5, at step 511, the interleaved beacon batch scheduler module 315 schedules the one or more assistive beacon batches based on the one or more least unused broadcast channels, the beacon batch window, the per window beacon density, and the beacon batch chaining time interval. Further, the interleaved beacon batch scheduler module 315 generates the one or more main adaptive broadcast streams including the adaptive broadcast support information included in the adaptive broadcast support 609-2 field and the broadcast stream identifier 603-1 embedded in the header 607-1 of the one or more main adaptive broadcast streams.

Further, at step 513, the broadcast transmitter 101 transmits, by interleaving with one or more main adaptive broadcast streams, the one or more assistive beacon batches in accordance with the scheduling. According to embodiment, the broadcast transmitter 101 interleave, in the beacon batch window, the one or more assistive beacon batches including the correlated broadcast beacon packets at the beacon batch chaining time interval. Thus, according to the disclosed method, the broadcast transmitter 101 embeds correlation information for the broadcast stream in the beacon batch. Further, the beacon contains the stream ID which is a primary key information to uniquely identify the broadcast stream thereby helps in maintaining the co-relation between the actual stream and the adaptive information.

According to an embodiment, the adaptive broadcast transmission is a configurable parameter. It can be either enabled or disabled based on the user input user. In an embodiment, consider that the broadcast transmitter 101 receives the user input for a disablement of the adaptive broadcast mode. This triggers a tear-down request to cease streaming of a current set of beacon batches. According to an embodiment, the beacon batch generator & teardown module 313, at block 413, triggers a tear-down request to cease streaming of the current set of assistive beacon batches among the one or more assistive beacon batches. Further, the beacon batch generator & teardown module 313 terminates the next set of assistive beacon batch that are scheduled in the beacon batch window at a next time instance with respect to a current time instance. This ensures that the broadcast receiver does not suddenly stop receiving adaptive broadcast without any pre-awareness, causing misbehavior. Further, the beacon batch generator & teardown module 313 sends interrupt event to the adaptive wireless broadcast handler 337. The adaptive streaming stop is triggered by the adaptive wireless broadcast handler 337.

In an embodiment, the current set of assistive beacon batches is allowed for transmission in the beacon batch window at the current time instance. Thus, after the complete termination of the next set of assistive beacon batches, the broadcast transmitter 101 transmits default broadcast streams. In an embodiment, the broadcast transmitter 101 continuous to transmit the default broadcast streams till the user input to re-enablement of the adaptive broadcast mode is being received.

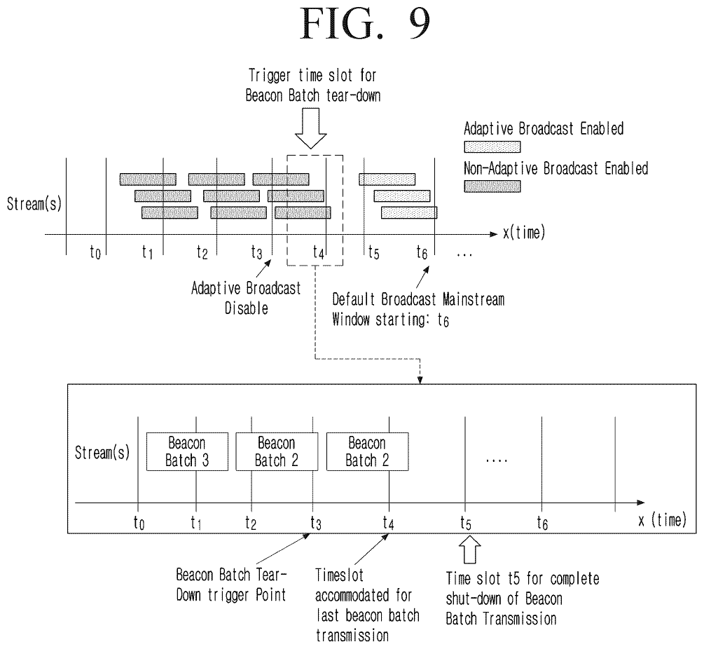

FIG. 9 illustrates an example of the adaptive beacon batch tear-down & synchronization with the main broadcast stream, according to an embodiment of the present disclosure. Consider that at time slot t3 the user input to disable the adaptive broadcast mode is being received. Further, at time slot t4 trigger time slot for beacon batch tear down started. Thus, as can be seen during batch 2 the beacon batch teardown trigger window started. Accordingly, batch 2 which is the current set of batches is being accommodated and allowed for its complete transmission. However, at time slot T5 there is a complete shut-down of beacon batch transmission.

Detailed working of the broadcast receiver 103 will be explained in detail through FIG. 4 to FIG. 12 in the forthcoming paragraphs.

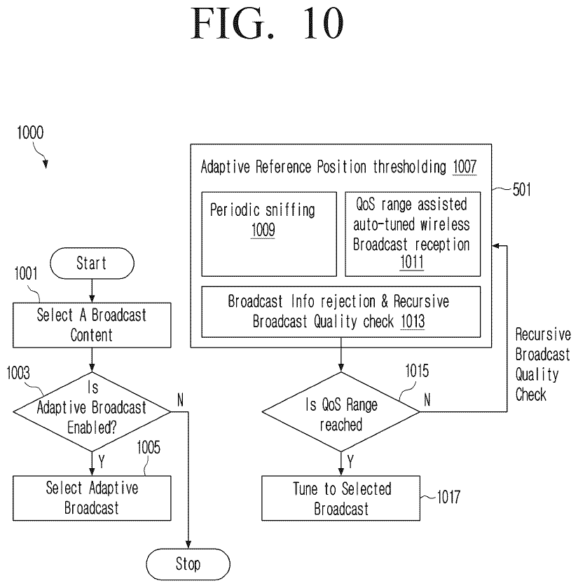

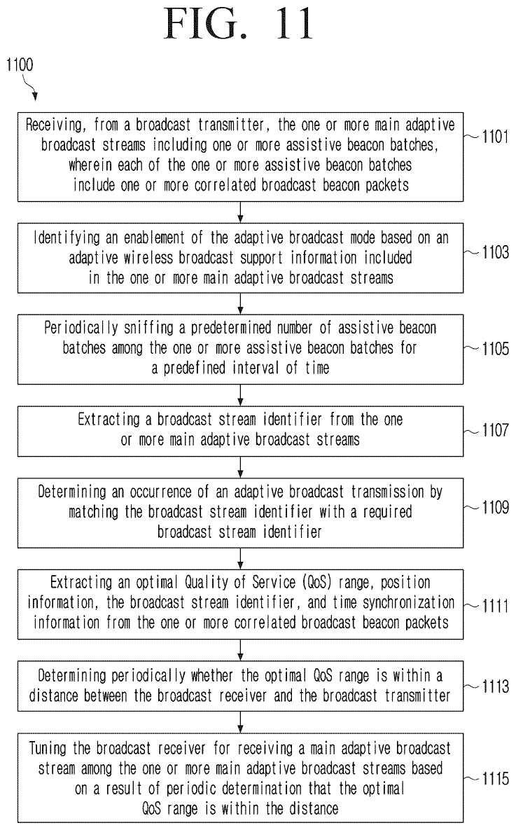

FIG. 10 illustrates an operational flow of the broadcast receiver 101, according to an embodiment of the present disclosure. The operation flow 1000 is implemented in the broadcast receiver 103 and will be explained through various operation steps 1001 to 1017. Further, FIG. 11 illustrates a flow chart of the operation flow 1100 and hence will be explained collectively with the operation flow 1000 for the sake of brevity and ease of reference. Accordingly, an explanation of the operation flow 1000 will be explained in the forthcoming paragraphs and through FIG. 3 and FIG. 10 to FIG. 12. Further, the reference numerals were kept the same for the similar components throughout the disclosure for ease of explanation and understanding.

Initially, at step 1001, the user may select ‘A’ broadcast content. After selection, at step 1003, the broadcast receiver 103 checks if the adaptive broadcast feature is supported and the transmitted broadcast stream supports adaptive wireless broadcast transmission, then the user will select the adaptive broadcast feature in the similar manner as explained in FIG. 1. In an embodiment, if the adaptive broadcast feature is supported, but the transmitted broadcast stream support does not support the adaptive wireless broadcast mode, then the user can select the default wireless broadcast transmission. In an embodiment, the adaptive broadcast is identified by the adaptive broadcast bit enabled in the broadcast stream.

In an embodiment, after the enablement of the adaptive wireless broadcast mode, at step 1005 the adaptive wireless broadcast transmission started and the broadcast receiver 103, performs the adaptive reference position thresholding 1007 for extracting various spatial aware information that is embedded in the main adaptive broadcast stream and thereby checking optimal reception quality of the broadcast content.

Accordingly, and referring to FIG. 11, at step 1101 the broadcast receiver 103 receives, from a broadcast transmitter, the one or more main adaptive broadcast streams including one or more assistive beacon batches. Further, each of the one or more assistive beacon batches includes one or more correlated broadcast beacon packets. Further, at step 1103, the broadcast receiver 103, identifies the enablement of the adaptive broadcast mode based on an adaptive wireless broadcast support information included in the one or more main adaptive broadcast streams. The adaptive broadcast is identified by the adaptive broadcast bit enabled in the broadcast stream. Step 1103 corresponds to the steps 1003 and 1005.

According to an embodiment, the adaptive reference position thresholding 1007 includes a periodic sniffing 1009 process and a QoS range assisted auto-tuned wireless broadcast reception 1011 process. In an embodiment, both process 1009 and 1011 ensure adaptive broadcast beacons are received, co-related with broadcast stream ID, followed by extraction of position and QoS range estimates. The adaptive broadcast beacons are also marked with adaptive broadcast stream ID (i.e., stream ID). The forthcoming paragraphs will explain the periodic sniffing 1009 process and the QoS range assisted auto-tuned wireless broadcast reception 1011 process in detail.

Referring back to FIG. 11, at step 1105, the beacon sniffer module 319 of the position thresholder module 317, periodically sniffs a predetermined number of assistive beacon batches among the one or more assistive beacon batches for a predefined interval of time. In particular, as the user turns on adaptive wireless broadcast for a particular stream which is selected by the user, and identified by the stream ID, the broadcast receiver 103 is interrupted and starts sniffing for broadcast beacons on periodic intervals.

In a non-limiting example, the broadcast beacon window length range may be between 100 milliseconds˜and 3000 milliseconds. Accordingly, the broadcast receiver 103 may sniff for a period. In a non-limiting example, consider that the sniffing time period is 300 milli-seconds (3 times minimum beacon batch window) to detect the presence of adaptive broadcast transmission from any nearby adaptive broadcast transmitter. If any transmitter is transmitting the adaptive broadcast beacon, within, for example, 3 seconds, such beacons will be detected. Further, after 3 seconds, if any adaptive broadcast beacon is sniffed, it identifies the broadcast stream by the unique stream ID.

In an embodiment, if the beacons are not sniffed, then, the broadcast receiver 103 schedules a timer for a specific time for example 3 seconds and continues sniffing for the given sniffing time period i.e. another 300 milliseconds. Thus, the method ensures no broadcast beacon batch is missed at any point in time.

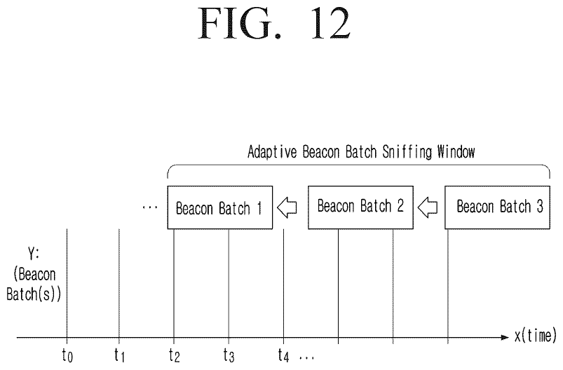

FIG. 12 illustrates an adaptive beacon batch sniffing in the adaptive beacon batch sniffing window, according to an embodiment of the present disclosure. According to an example embodiment, the beacon sniffer module 319 sniffs at-least 20 broadcast beacon batch packets to ensure data integrity, thus avoiding sniffing of older or obsolete data. Further, if the broadcast receiver 103 receives less than 20 beacons, then it checks the next broadcast beacon batch transmission time from the time Sync info of the beacon header. According to an embodiment, the broadcast receiver 103 enables sniffing in the next beacon batch window from the interval found in the previous beacon batch.

Further at step 1107, the beacon sniffer module 319 extracts a broadcast stream identifier from the one or more main adaptive broadcast streams. Further, at step 1109, the beacon sniffer module 319 determines an occurrence of an adaptive broadcast transmission by matching the broadcast stream identifier with a required broadcast stream identifier.

According to an embodiment, the broadcast receiver 103 keeps a counter to count the number of beacons with marked stream ID for matching 100 packets. If 20 packets are received, then the broadcast receiver 103 is ensured that adaptive broadcast streaming is on. According to an embodiment, the broadcast receiver 103 switches from beacon sniffing to broadcast stream receiving mode immediately and starts to match the stream ID to find if the intended broadcast stream ID matches with the sniffed broadcast stream ID. If matched, it indicates that the adaptive broadcast stream is under transmission.

Further, at step 1111, the beacon sniffer module 319 extracts the optimal QoS range, the position information, the broadcast stream identifier, and time synchronization information from the one or more correlated broadcast beacon packets when the intended broadcast stream ID matches with the sniffed broadcast stream ID.

In an embodiment, the broadcast receiver 103 stores the position information, the QoS range estimates marked by the adaptive broadcast stream ID. Although the QoS range parameter is probabilistic, it provides a good indication of the desired radio range within which, the best reception is possible, as multi-path loss and fade margin variables are considered for deriving the QoS radio range. Further, position information also plays a vital role in maintaining the quality of reception. The broadcast receiver 103, if too far away from the broadcast transmitter 101 can result in a drop of too many broadcast packets or even bad quality reception thereby leading to an unfavorable user experience. Accordingly, the QoS range-assisted auto-tuned wireless broadcast reception 1011 process helps in tuning the broadcast receiver 103 to receive the best quality reception.

Accordingly, at step 1113, the auto-tuner module 321 determines periodically whether the optimal QoS range is within a distance between the broadcast receiver 103 and the broadcast transmitter 101. In an embodiment, the auto-tuner module 321 computes the position of the broadcast receiver 103 based on sensor data and the GPS data obtained from a plurality of sensors in the broadcast receiver 103. The computation technique of the position of the broadcast receiver 103 is the same as that of the broadcast transmitter 101. The auto-tuner module 321 further computes the distance (d) between the broadcast receiver 103 and the broadcast transmitter 101 based on the position information of the broadcast transmitter 101 and the position of the broadcast receiver 103.

According to an embodiment, the broadcast receiver 103 derives the distance (d) between the between the broadcast receiver 103 and the broadcast transmitter 101 based on equation 12.

$$d = √ ( {( x 2 - x )}^{2} + {( y 2 - y 1 )}^{2} ) \qquad ( 12 )$$

In an embodiment, the broadcast receiver 103 may use techniques like AOA (Angle of arrival) to determine the range (d1) between the broadcast receiver 103 and the broadcast transmitter 101. AOA technique uses the direction of the received signal by the broadcast receiver 103, over an antenna array. Both the above methods are co-related (d & d1) to find the best position estimate of the broadcast transmitter 101, by taking the mean of all the estimates based on equation 13.

$$mean = - D = \sum n ( i = 1 ) * di / n ( n = 2 ¨ 5 ) \qquad ( 13 )$$

where, D=distance between transmitter & receiver; and
n=total number of distance finding methods.

According to an embodiment, the validator module 323 determines, at step 1015 of FIG. 10, if the distance computed is within the QoS range estimate and a delta coefficient, then broadcast tuned immediately at step 1115 (i.e., in case d<=qr). That is the auto-tuner module 321, at step 1017, tune the broadcast receiver 103 for receiving a main adaptive broadcast stream among the one or more main adaptive broadcast streams when determined that the optimal QoS range is within the distance. Further, the broadcast receiver 103 auto-latches to the broadcast stream. This ensures the best quality reception of the broadcast content.

Further, if the validator module 323 determines that the distance computed is greater than the QoS range estimate and delta coefficient, then the broadcast is not tuned immediately (i.e., d>qr) by the Auto-tuner module 321. In the latter case i.e., when it was found that the distance computed is greater than the QoS range estimate and the delta coefficient, a teardown of the broadcast stream is triggered. That is the auto-tuner module 321 drops the main adaptive broadcast stream. Then the broadcast receiver 103 performs a recursive broadcast quality check and starts periodic scheduling of QoS range estimation with an interval of 1 sec. The process is repeated until the (d<=qr) condition is met or until the user stops the wireless broadcast or switches to another broadcast stream.

The disclosed method allows offloading in the processing overhead of the main adaptive broadcast streams by generating the one or more correlated broadcast beacon packets embedded with determined real-time position information along with the broadcast stream identifier, and time synchronization information. Now as the broadcast stream identifier is shared via the header of the main broadcast adaptive stream, the broadcast receiver 103 identifies the particular broadcast content from the stream ID embedded in it. This helps in reducing the processing overheads. Further, the main adaptive broadcast packets are shared on the unused channels thereby allowing a faster reception by the broadcast receiver. Further, at the broadcast receiver end the broadcast receiver recursively checks and validates the QoS range so that the best quality reception can be received.

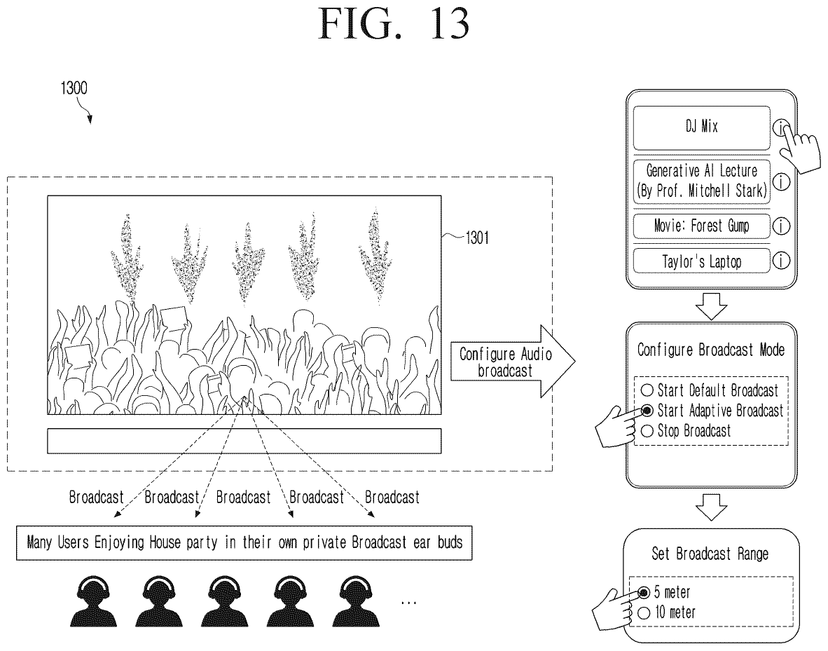

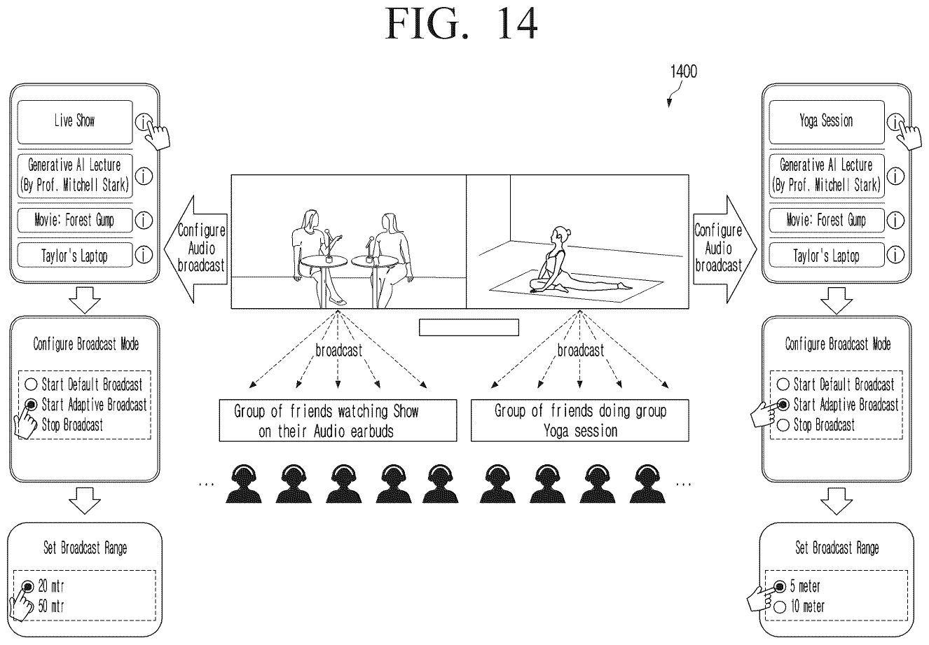

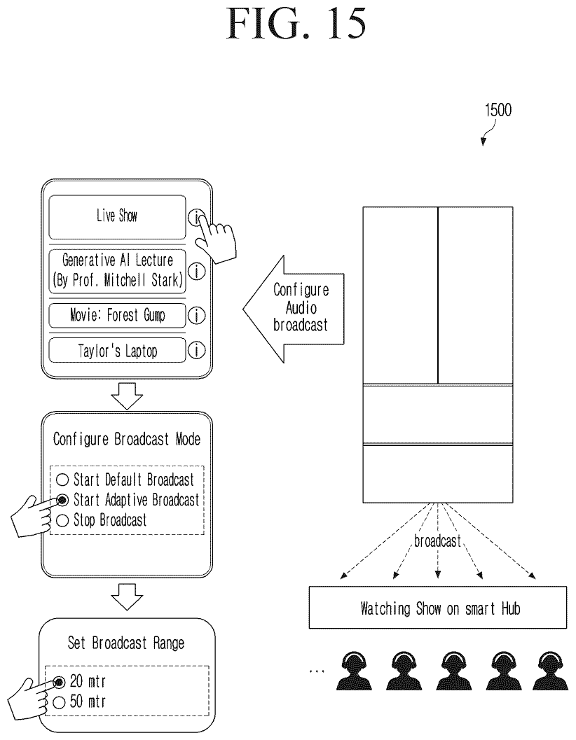

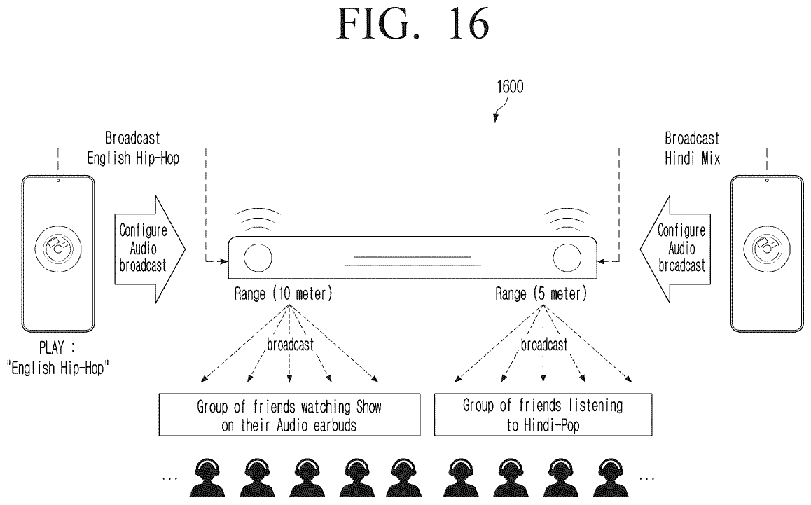

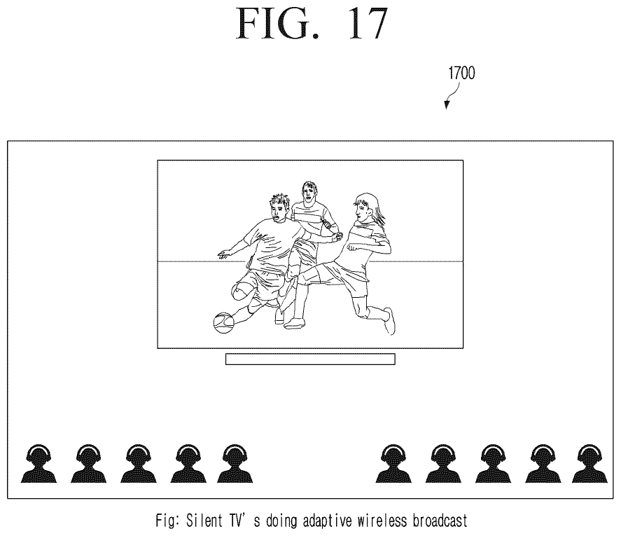

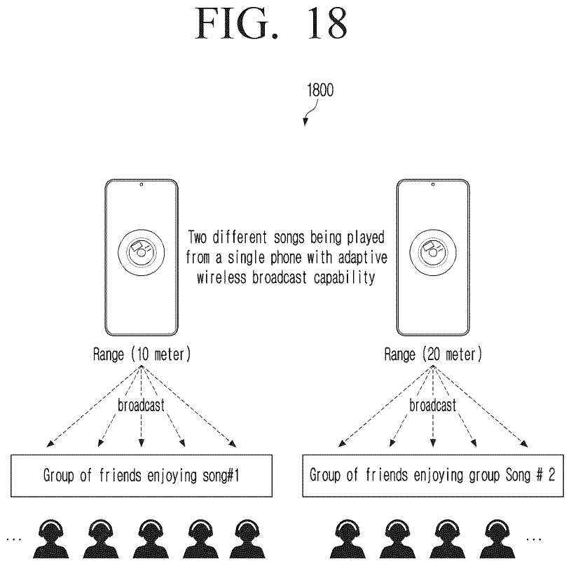

The forthcoming paragraphs disclose the use cases of the above-implemented technique. FIG. 13 to FIG. 18 illustrate various example scenarios, according to an embodiment of the present disclosure. The example scenarios as depicted in FIG. 11 to FIG. 19 are implemented with method 500 and method 1100. Accordingly, in the example scenario 1300, consider that for a house-party, the broadcast transmitter i.e. a TV 1301 starts an audio broadcast by selecting the house party DJ as the broadcast content. The user may select the adaptive broadcast mode for the transmission of the broadcast content. Further, the users may set the broadcast range as 20 meters. Thus, in an example embodiment, the QoS Range is set to ˜20 meters. Thus, many users enjoy the house party with their own private earbuds. Further, anyone trying to tune into a broadcast beyond this range will not experience audio.

According to another example scenario 1400, two different groups of users are configured with different QoS range and receives different streams like a TV show and a yoga session. Thus, the present disclosure allows multi-stream broadcasting when the broadcaster is a multi-stream device.

According to a further example scenario 1500, the users may enjoy the broadcast content from a smart hub while setting an appropriate QoS range. Accordingly, no user beyond this range will be able to get reception (outside the viewing distance of the smart hub).

According to a yet further example scenario 1600, the multi-stream adaptive audio broadcast can be controlled simultaneously. As can be seen, two different payloads are streamed through a common sound configured with different QoS range sets. Accordingly, both batches of users can watch and listen to the audio simultaneously.

According to a further example scenario 1700, the users may configure range-bound audio wireless broadcast in a sports bar setup. According to the example scenario, the TVs installed in the sports Bar can be silent TVs, each TV playing different contents. Further, the TVs can play either video content or audio-only content. Further, the viewers can use their adaptive broadcast-capable mobile phone and ear-buds to enjoy the AV contents of their choice.

According to a further example scenario 1800, the adaptive broadcaster can play two different broadcast content from a single device. Further, the adaptive broadcaster can broadcast different broadcast content to different groups of users.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method of adaptive wireless broadcast communication comprising:
receiving an input configured to enable an adaptive broadcast mode of a broadcast transmitter;
based on the received input, determining an optimal Quality of Service (QoS) range in which the broadcast transmitter is able to transmit data to a receiver without data loss and position information of the broadcast transmitter;
generating a broadcast beacon packet correlated to a main broadcast packet and embedded with the determined optimal QoS range, the determined position information, a broadcast stream identifier, and time synchronization information;
generating an assistive beacon batch corresponding to a broadcast stream, the assistive beacon batch including the generated broadcast beacon packet;
based on at least one of a total number of active broadcast streams, window length information, and channel map information, determining an unused broadcast channel from among a plurality of broadcast channels of the broadcast transmitter, a beacon batch window, a per window beacon density, or a beacon batch chaining interval;
scheduling the assistive beacon batch to be transmitted based on the determined unused broadcast channel, the determined beacon batch window, the determined per window beacon density, or the determined beacon batch chaining time interval; and
transmitting the scheduled assistive beacon batch in accordance with the scheduling by interleaving the scheduled assistive beacon batch with an adaptive broadcast stream.

2. The method of claim 1, further comprising:
monitoring periodically a position of the broadcast transmitter,
determining, within a time interval, updated position information corresponding to a change in the position of the broadcast transmitter based on the monitoring, and
updating, based on determination of the change in the position of the broadcast transmitter, the assistive beacon batch by embedding the determined updated position information into the assistive beacon batch, wherein the determined position information embedded in the broadcast beacon packet is updated to include the determined updated position information.

3. The method of claim 1, wherein the determining the position information of the broadcast transmitter includes:
receiving acceleration data and/or global positioning service (GPS) data from a sensor of the broadcast transmitter, and
determining the position information based on the received acceleration data and/or the received GPS data.

4. The method of claim 2, wherein the determining the updated position information corresponding to the change in the position of the broadcast transmitter includes:
receiving acceleration data and/or global positioning service (GPS) data from a sensor of the broadcast transmitter, and
determining, within the time interval, the updated position information based on the received acceleration data and/or the received GPS data, wherein the updated position information is position information of the broadcast transmitter with respect to an immediate previous position of the broadcast transmitter.

5. The method of claim 2, wherein the determining the optimal QoS range includes accounting for the change in the position of the broadcast transmitter by including:
monitoring a parameter of a sensor of the broadcast transmitter,
determining a path loss based on the monitored parameter, and
determining the optimal QoS range with respect to the change in the position of the broadcast transmitter based on the determined path loss.

6. The method of claim 5, wherein the monitored parameter includes at least one of an output power of the broadcast transmitter, a sensitivity of a receiver configured to receive a broadcast of the broadcast transmitter, a physical obstacle in a transmission path between the broadcast transmitter and the receiver, and an antenna gain obtained from the sensor.

7. The method of claim 1, further comprising:
generating the adaptive broadcast stream including adaptive broadcast support information and the broadcast stream identifier embedded in a header of the adaptive broadcast stream,
wherein the adaptive broadcast support information indicates whether the adaptive broadcast mode is enabled or disabled, and
the broadcast stream identifier identifies the broadcast stream that is broadcasted via the adaptive broadcast stream.

8. The method of claim 1, wherein
the assistive beacon batch is scheduled to be transmitted before an onset of transmission of the adaptive broadcast stream, and
transmission of the generated broadcast beacon packet included in the scheduled assistive beacon batch starts at an immediate time slot after the adaptive broadcast mode is enabled.

9. The method as claimed in claim 1, wherein transmitting the scheduled assistive beacon batch includes:
interleaving, in the determined beacon batch window, the assistive beacon batch including the generated broadcast beacon packet at the determined beacon batch chaining time interval, each generated broadcast beacon packet including a time stamp of a next periodic position update value, and
a receiver performs a decoding operation on the generated broadcast beacon packet at the time stamp of the next periodic position update value in case the receiver misses to perform the decoding operation in accordance with the time synchronization information.

10. The method of claim 1, further comprising:
receiving an input configured to disable the adaptive broadcast mode;
triggering a tear-down request to cease streaming of a current set of assistive beacon batches among a plurality of scheduled assistive beacon batches; and
terminating transmission of a next set of assistive beacon batches among the plurality of scheduled assistive beacon batches that are scheduled to be transmitted in the determined beacon batch window at a next time instance with respect to a current time instance,
wherein the current set of assistive beacon batches are allowed to be transmitted in the determined beacon batch window at the current time instance.

11. The method as claimed in claim 10, further comprising:
until an input to re-enable the adaptive broadcast mode is received, transmitting a default broadcast stream based on the termination of the next set of assistive beacon batches.

12. The method of claim 1, wherein
the beacon batch window represents a time period of transmitting the assistive beacon batch corresponding to the broadcast stream,
the generated broadcast beacon packet is among a plurality of generated broadcast beacon packets included in the assistive beacon batch, and the per window beacon density represents a number of generated broadcast beacon packets in the assistive beacon batch, and
the beacon batch chaining interval represents a time interval between a start of the beacon batch window and a start of a previous batch window.

13. A method of adaptive wireless broadcast communication comprising:
receiving, by a broadcast receiver, an adaptive broadcast stream including an assistive beacon batch, the assistive beacon batch including a broadcast beacon packet correlated to a main broadcast packet;
identifying an adaptive broadcast mode being enabled based on adaptive wireless broadcast support information included in the received adaptive broadcast stream;
periodically sniffing a predetermined number of assistive beacon batches among a plurality of assistive beacon batches for an interval of time;
extracting a broadcast stream identifier from the received adaptive broadcast stream;
determining an occurrence of an adaptive broadcast transmission by matching the extracted broadcast stream identifier with a required broadcast stream identifier;
extracting an optimal Quality of Service (QoS) range in which a broadcast transmitter is able to transmit data to the broadcast receiver without data loss, position information of the broadcast transmitter, the broadcast stream identifier, and time synchronization information from the broadcast beacon packet included in the received adaptive broadcast stream;
determining periodically whether the extracted optimal QoS range is within a distance between the broadcast receiver and the broadcast transmitter; and
based on the extracted optimal QoS range being determined to be within the distance, tuning the broadcast receiver to receive the adaptive broadcast stream.

14. The method as claimed in claim 13, further comprising:
storing the extracted optimal QoS range, the extracted position information, the extracted broadcast stream identifier, and the extracted time synchronization information.

15. A broadcast transmitter comprising:
at least one processor configured to:
receive an input configured to enable an adaptive broadcast mode of the broadcast transmitter,
based on the received input, determine an optimal Quality of Service (QoS) range in which the broadcast transmitter is able to transmit data to a receiver without data loss and position information of the broadcast transmitter,
generate a broadcast beacon packet correlated to a main broadcast packet and embedded with the determined optimal QoS range, the determined position information, a broadcast stream identifier, and time synchronization information,
generate an assistive beacon batch corresponding to a broadcast stream, the assistive beacon batch including the generated broadcast beacon packet,
based on at least one of a total number of active broadcast streams, window length information, and channel map information, determine an unused broadcast channel from among a plurality of broadcast channels of the broadcast transmitter, a beacon batch window, a per window beacon density, or a beacon batch chaining interval,
schedule the assistive beacon batch to be transmitted based on the determined unused broadcast channel, the determined beacon batch window, the determined per window beacon density, or the determined beacon batch chaining time interval, and
transmit the scheduled assistive beacon batch by interleaving the scheduled assistive beacon batch with an adaptive broadcast stream.

16. The broadcast transmitter of claim 15, wherein the at least one processor is further configured to:
monitor periodically a position of the broadcast transmitter,
determine, within a time interval, updated position information corresponding to a change in the position of the broadcast transmitter based on the monitoring, and update, based on determination of the change in the position of the broadcast transmitter, the assistive beacon batch by embedding the determined updated position information into the assistive beacon batch,
wherein the determined position information embedded in the broadcast beacon packet is updated to include the determined updated position information.

17. The broadcast transmitter of claim 15, wherein to determine the position information of the broadcast transmitter, the at least one processor is configured to:
receive acceleration data and/or global positioning service (GPS) data from a sensor of the broadcast transmitter, and
determine the position information based on the received acceleration data and/or the received GPS data.

18. The broadcast transmitter of claim 16, wherein to determine the updated position information corresponding to the change in the position of the broadcast transmitter, the at least one processor is configured to:
receive acceleration data and/or global positioning service (GPS) data from a sensor of the broadcast transmitter, and
determine, within the time interval, the updated position information based on the received acceleration data and/or the received GPS data,
wherein the updated position information is position information of the broadcast transmitter with respect to an immediate previous position of the broadcast transmitter.

19. The broadcast transmitter of claim 16, wherein to determine the optimal QoS range accounting for the change in the position of the broadcast transmitter, the at least one processor is configured to:
monitor a parameter of a sensor of the broadcast transmitter,
determine a path loss based on the monitored parameter, and
determine the optimal QoS range with respect to the change in the position of the broadcast transmitter based on the determined path loss.

20. The broadcast transmitter of claim 19, wherein the monitored parameter includes at least one of an output power of the broadcast transmitter, a sensitivity of a receiver configured to receive a broadcast of the broadcast transmitter, a physical obstacle in a transmission path between the broadcast transmitter and the receiver, and an antenna gain obtained from the sensor.
